(19) United States
(12) Patent Application Publication
(10) Pub. No.: US 2018/0333832 A1
(43) Pub. Date: Nov. 22, 2018

(54) PIPE CLAMP PLIERS

(71) Applicant: Huo-Meng Technology Co., Ltd., Taichung City (TW)

(72) Inventor: Chao-Min LIU, Taichung City (TW)

(21) Appl. No.: 15/596,289

(22) Filed: May 16, 2017

(51) Int. Cl. B25B 25/00; B25B 7/02; F16L 33/025

(52) U.S. Cl. CPC B25B 25/005; F16L 33/025; B25B 7/02

(57) ABSTRACT

The pipe clamp pliers includes a first and a second clamping members. The first clamping member has a first and a second ends, and further has a first pivot portion between the first and the second ends. A first clamping portion is provided at the first end. The second clamping member has a third and a fourth ends, and further has a second pivot portion between the third and the fourth ends. A second clamping portion is provided at the third end. The second pivot portion is pivotally connected with the first pivot portion. The first and the second clamping portions are formed with a first and a second horizontal grooves. At least one of a corner of the first horizontal groove near the first pivot portion and a corner of the second horizontal groove near the second pivot portion is smaller than 90 degrees.

### BACKGROUND OF THE INVENTION

### Field of the Invention

The present invention relates to a pipe clamp pliers.

### Description of the Prior Art

A conventional pipe clamp pliers for loosening pipe clamp is shown in patent TW M287208. The pipe clamp pliers has a sliding sleeve having a fixed pushing element and a slidable pushing element. The slidable pushing element can be moved by a pliers. When the two leg portions of the pipe clamp abut against the two pushing elements respectively, the slidable pushing element is moved toward the fixed pushing element by pressing the pliers. Thus, the distance between the two leg portions is shortened, and the pipe clamp is loosened.

However, the structure is not easy to operate. More specifically, the sliding sleeve and the pliers are independent from each other. Thus, a user has to be arrange the two pushing elements on the two leg portions of the pipe clamp first. And then, the user holds the sliding sleeve with one hand and operates the pliers. Therefore, the operation is difficult and is not efficient.

Thus, some users use the common pliers to clamp the two leg portions of the pipe clamp. However, the contact area is extremely small, so the pipe clamp may slip easily.

### SUMMARY OF THE INVENTION

The main object of the present invention is to provide a pipe clamp pliers which is easy to clamp the leg portions of the pipe clamp to loosen the pipe clamp.

To achieve the above and other objects, the pipe clamp pliers of the present invention includes a first clamping member and a second clamping member.

The first clamping member has a first end and a second end. The first clamping member further has a first pivot portion located between the first end and the second end. A first clamping portion is provided at the first end. A first holding portion is provided at the second end. A first direction is defined as a direction that the first end and the second end are aligned. The second clamping member has a third end and a fourth end. The second clamping member further has a second pivot portion located between the third end and the fourth end. The second pivot portion is pivotally connected with the first pivot portion. A second clamping portion is provided at the third end. A second holding portion is provided at the fourth end. A second direction is defined as a direction that the third end and the fourth end are aligned.

A first horizontal groove is formed on a face of the first clamping portion facing the second clamping portion. A second horizontal groove is formed on a face of the second clamping portion facing the first clamping portion. The second horizontal groove positionally corresponds to the first horizontal groove. The first horizontal groove is substantially perpendicular to the first direction, and the second horizontal groove is substantially perpendicular to the second direction. The first horizontal groove has a first bottom face, a first lateral face, and a second lateral face. The first lateral face is closer to the first pivot portion than the second lateral face is. The second horizontal groove has a second bottom face, a third lateral face, and a fourth lateral face. The third lateral face is closer to the second pivot portion than the fourth lateral face is. A first angle is defined between the first lateral face and the first bottom face, and a second angle is defined between the third lateral face and the second bottom face. At least one of the first angle and the second angle is smaller than 90 degrees.

Thereby, the pipe clamp pliers can clamp the pipe clamp easily and firmly.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a partial stereogram of the present invention;

FIG. 3A is a lateral view of a first clamping portion of the present invention;

FIG. 3B is a top view of a second clamping portion of the present invention;

FIG. 4 is an illustration of the present invention;

FIG. 5 is a lateral view of the present invention;

FIG. 6 is an illustration of the present invention.

### DETAILED DESCRIPTION OF THE PREFERRED EMBODIMENTS

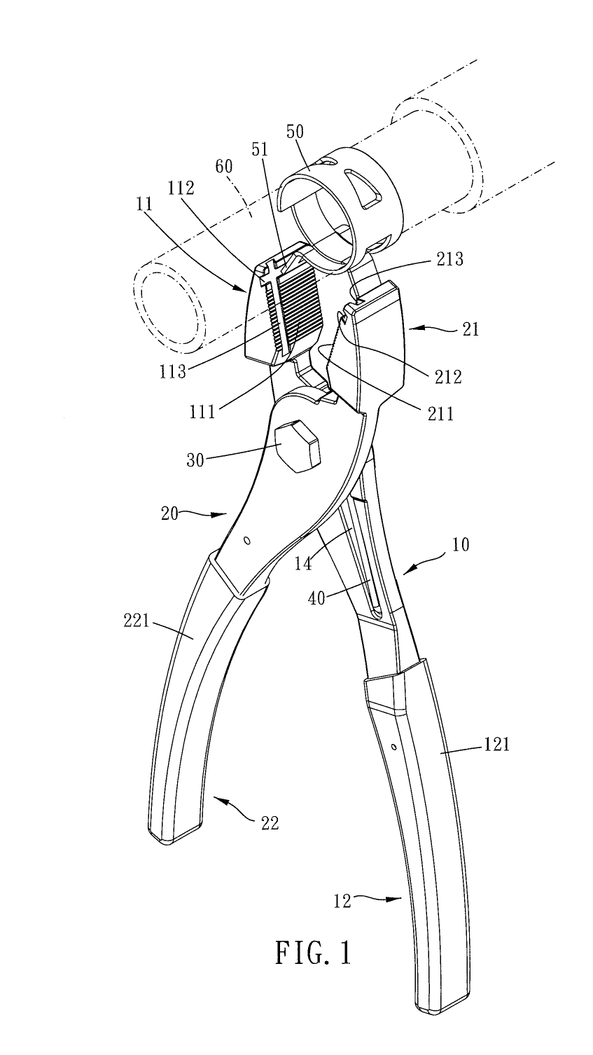

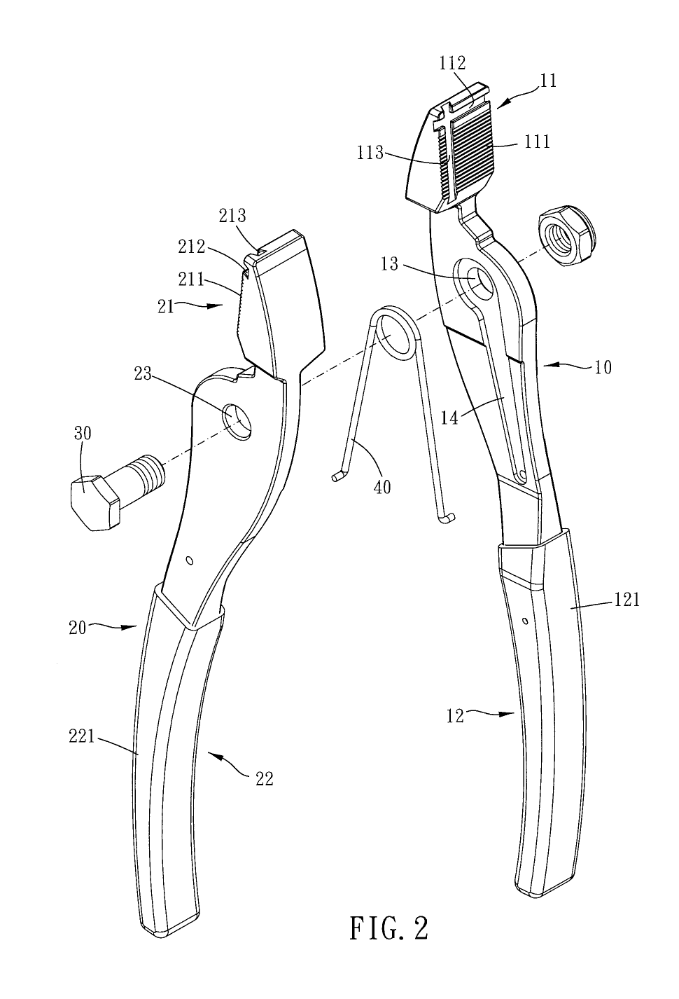

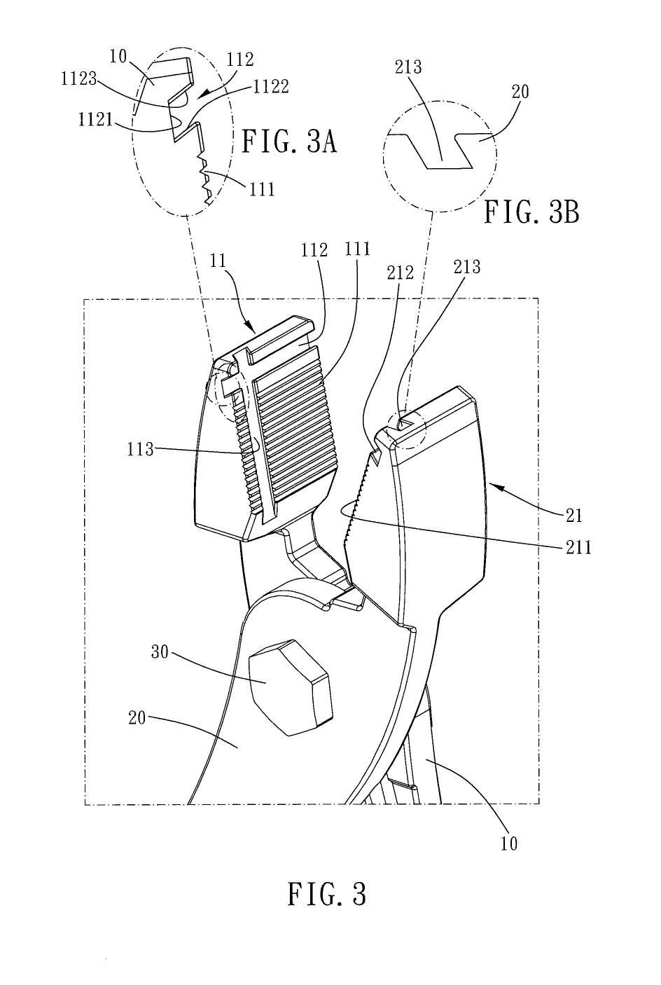

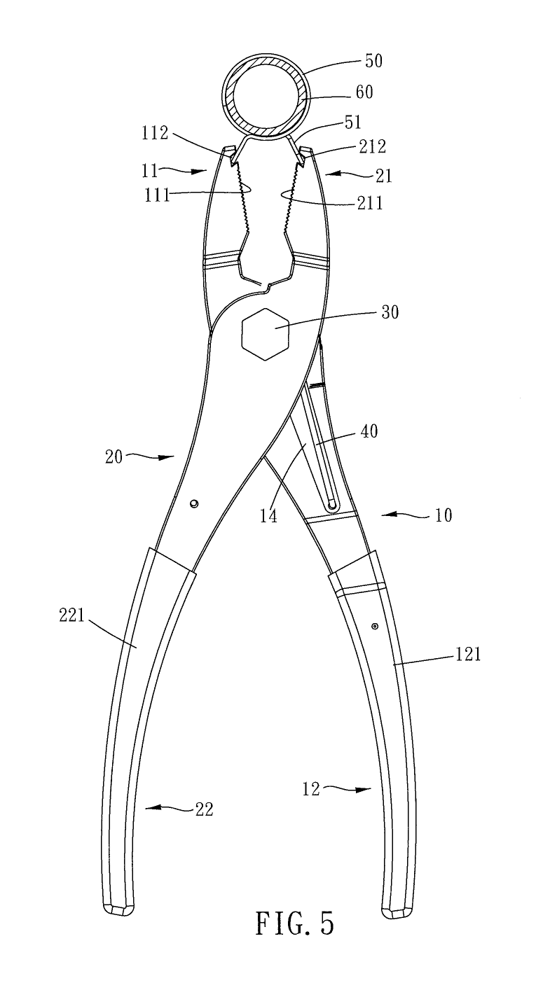

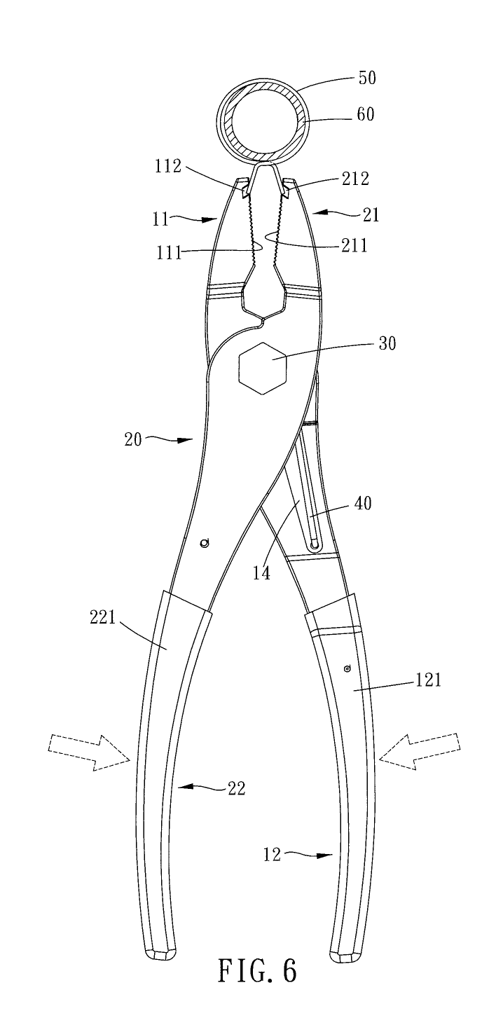

Please refer to FIGS. 1 to 6, FIG. 3A, and FIG. 3B, a pipe clamp pliers of the present invention includes a first clamping member 10 and a second clamping member 20.

The first clamping member 10 has a first end 11 and a second end 12. The first clamping member 10 further has a first pivot portion located between the first end 11 and the second end 12. A first clamping portion is provided at the first end 11. A first holding portion is provided at the second end 12. A first direction is defined as a direction that the first end 11 and the second end 12 are aligned.

The second clamping member 20 has a third end 21 and a fourth end 22. The second clamping member 20 further has a second pivot portion located between the third end 21 and the fourth end 22. The second pivot portion is pivotally connected with the first pivot portion. A second clamping portion is provided at the third end 21. A second holding portion is provided at the fourth end 22. A second direction is defined as a direction that the third end 21 and the fourth end 22 are aligned.

A first horizontal groove 112 is formed on a face of the first clamping portion facing the second clamping portion. A second horizontal groove 212 is formed on a face of the second clamping portion facing the first clamping portion. The second horizontal groove 212 positionally corresponds to the first horizontal groove 112. The first horizontal groove 112 is substantially perpendicular to the first direction. The second horizontal groove 212 is substantially perpendicular to the second direction. The first horizontal groove 112 has a first bottom face 1121, a first lateral face 1122, and a second lateral face 1123. The first lateral face 1122 is closer to the first pivot portion than the second lateral face 1123 is. The second horizontal groove 212 has a second bottom face, a third lateral face, and a fourth lateral face. The third lateral face is closer to the second pivot portion than the fourth lateral face is. A first angle is defined between the first lateral face 1122 and the first bottom face 1121. A second angle is defined between the third lateral face and the second bottom face. At least one of the first angle and the second angle is smaller than 90 degrees.

Practically, both of the first angle and the second angle are smaller than 90 degrees. Preferably, the first angle is ranged from 50 to 70 degrees, more preferably 60 degrees. The second angle is also ranged from 50 to 70 degrees, more preferably 60 degrees. That is, the lateral faces for leg portions 51 of a pipe clamp 50 to abutting against are inclined so as to prevent the leg portions 51 from slipping. Furthermore, the angle between the second lateral face 1123 and the first bottom face 1121 is larger than 90 degrees, and the angle between the fourth lateral face and the second bottom face is also larger than 90 degrees. The first lateral face 1122 and the second lateral face 1123 are substantially parallel to each other. The third lateral face and the fourth lateral face are also substantially parallel to each other. The face of the first clamping portion facing the second clamping portion is substantially parallel to the first bottom face 1121, and the face of the second clamping portion facing the first clamping portion is substantially parallel to the second bottom face. A width of the first bottom face 1121 is 1.15-1.2 times a depth of the first horizontal groove 112. A width of the second bottom face is 1.15-1.2 times a depth of the second horizontal groove 212. As a result, the horizontal grooves can fit the conventional pipe clamp.

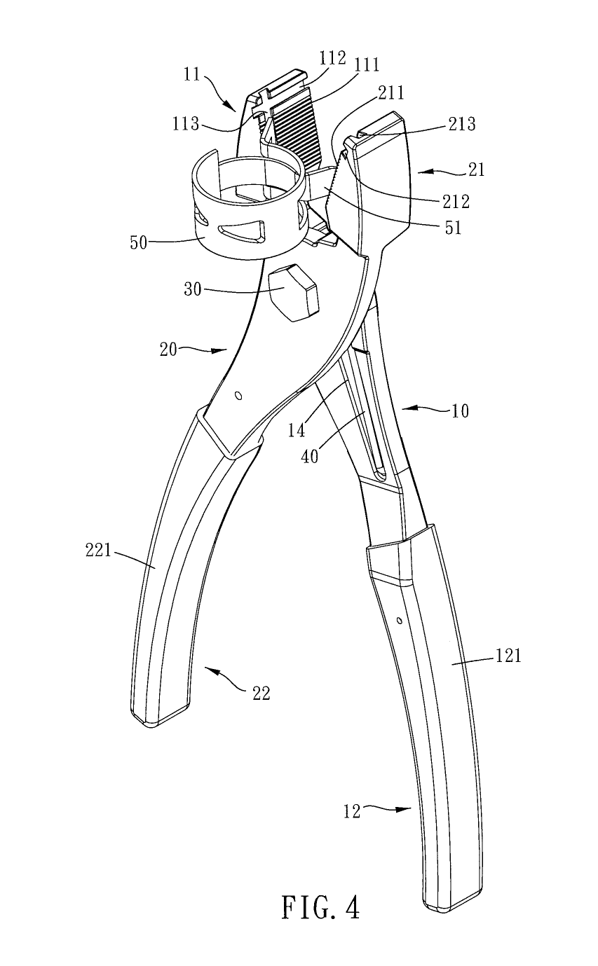

In the present embodiment, the first clamping portion is formed with a plurality of narrow grooves 111 on the face thereof facing the second clamping portion wherein the narrow grooves 111 are arranged spacedly. The second clamping portion is formed with a plurality of narrow grooves 211 on the face thereof facing the first clamping portion wherein the narrow grooves 211 are arranged spacedly. The narrow grooves 111,211 are parallel to the first horizontal groove 112 or the second horizontal groove 212 respectively. The narrow grooves 111,211 are adapted for prevent from slipping and also for clamp other objects from pipe clamps as a normal pliers. Preferably, the narrow grooves 111 of the first clamping portion are located between the first horizontal groove 112 and the first pivot portion, and the narrow grooves 211 of the second clamping portion are located between the second horizontal groove 212 and the second pivot portion. A width of each narrow groove 111 of the first clamping portion is smaller than a width of the first horizontal groove 112, and a width of each narrow groove 211 of the second clamping portion is smaller than a width of the second horizontal groove 212. Besides, the first clamping portion is formed with a first longitudinal groove 113 on the face thereof facing the second clamping portion, and the second clamping portion is formed with a second longitudinal groove 213 on the face thereof facing the first clamping portion wherein the second longitudinal groove 213 positionally corresponds to the first longitudinal groove 113. The first longitudinal groove 113 is parallel to the first direction and penetrates the narrow grooves 111 of the first clamping portion. The second longitudinal groove 213 is parallel to the second direction and penetrates the narrow grooves 211 of the second clamping portion. The first longitudinal groove 113 communicates with the first horizontal groove 112, and the second longitudinal groove 213 communicates with the second horizontal groove 212. Preferably, the first longitudinal groove 113 is near one of the lateral faces of the first clamping portion, and the second longitudinal groove 213 is near one of the lateral faces of the second clamping portion. An angle between a bottom face of the first longitudinal groove 113 and a lateral face of the first longitudinal groove 113 more remote from said lateral face of the first clamping portion is smaller than 90 degrees. An angle between a bottom face of the second longitudinal groove 213 and a lateral face of the second longitudinal groove 213 more remote from said lateral face of the second clamping portion is smaller than 90 degrees. Due to the longitudinal grooves, the pipe clamp pliers can be used to clamp the pipe clamp 50 laterally, as shown in FIG. 4. Besides, two opposite ends of the first horizontal groove 112 penetrate two lateral faces of the first clamping portion respectively, and two opposite ends of the second horizontal groove 212 penetrate two lateral faces of the second clamping portion respectively. Two opposite ends of the first longitudinal groove 113 penetrate a top face and a bottom face of the first clamping portion respectively, two opposite ends of the second longitudinal groove 213 penetrate a top face and a bottom face of the second clamping portion respectively. Thus, the leg portions 51 of the pipe clamp 50 can be inserted into the grooves easily.

Specifically, the first clamping member 10 has a first receiving groove 14, and the second clamping member 20 has a second receiving groove. An elastic element 40 is arranged in the first receiving groove 14 and the second receiving groove so that the first clamping portion and the second clamping portion tend to move away from each other. Each of the first pivot portion and the second pivot portion is a pivot hole 13,23 and is located in the first receiving groove 14 or the second receiving groove. A pivot element 30 is inserted through the two pivot holes 13,23, and the elastic element 40 is sleeved onto the pivot element 30. A gripping sleeve 121,221 is sleeved onto each of the first holding portion and the second holding portion for gripping on.

In use, the inclined lateral faces of the first horizontal groove 112 and the second horizontal groove 212 make the leg portions 51 of the pipe clamp 50 sleeved on a pipe 60 easier to insert into the first horizontal groove 112 and the second horizontal groove 212. During the operation, the inclined lateral faces can stop the leg portions 51 from slipping. Thus, the efficiency is improved, and the user may not be hurt. Besides, if the space around the pipe clamp 50 is too narrow, the user can use the first longitudinal groove 113 and the second longitudinal groove 213 to clamp the pipe clamp 50.

What is claimed is:

1. A pipe clamp pliers including:
a first clamping member, having a first end and a second end, the first clamping member further having a first pivot portion located between the first end and the second end, a first clamping portion being provided at the first end, a first holding portion being provided at the second end, a first direction being defined as a direction that the first end and the second end are aligned;
a second clamping member, having a third end and a fourth end, the second clamping member further having a second pivot portion located between the third end and the fourth end, the second pivot portion being pivotally connected with the first pivot portion, a second clamping portion being provided at the third end, a second holding portion being provided at the fourth end, a second direction being defined as a direction that the third end and the fourth end are aligned;
wherein a first horizontal groove is formed on a face of the first clamping portion facing the second clamping portion, a second horizontal groove is formed on a face of the second clamping portion facing the first clamping portion, the second horizontal groove positionally corresponds to the first horizontal groove, the first horizontal groove is substantially perpendicular to the first direction, the second horizontal groove is substantially perpendicular to the second direction, the first horizontal groove has a first bottom face, a first lateral face, and a second lateral face, the first lateral face is closer to the first pivot portion than the second lateral face is, the second horizontal groove has a second bottom face, a third lateral face, and a fourth lateral face, the third lateral face is closer to the second pivot portion than the fourth lateral face is, a first angle is defined between the first lateral face and the first bottom face, a second angle is defined between the third lateral face and the second bottom face, at least one of the first angle and the second angle is smaller than 90 degrees.

2. The pipe clamp pliers of claim 1, wherein the first clamping portion is formed with a plurality of narrow grooves on the face thereof facing the second clamping portion wherein the narrow grooves are arranged spacedly, the second clamping portion is formed with a plurality of narrow grooves on the face thereof facing the first clamping portion wherein the narrow grooves are arranged spacedly, the narrow grooves are parallel to the first horizontal groove or the second horizontal groove respectively.

3. The pipe clamp pliers of claim 2, wherein the narrow grooves of the first clamping portion are located between the first horizontal groove and the first pivot portion, the narrow grooves of the second clamping portion are located between the second horizontal groove and the second pivot portion.

4. The pipe clamp pliers of claim 2, wherein a width of each narrow groove of the first clamping portion is smaller than a width of the first horizontal groove, a width of each narrow groove of the second clamping portion is smaller than a width of the second horizontal groove.

5. The pipe clamp pliers of claim 1, wherein two opposite ends of the first horizontal groove penetrate two lateral faces of the first clamping portion respectively, two opposite ends of the second horizontal groove penetrate two lateral faces of the second clamping portion respectively.

6. The pipe clamp pliers of claim 1, wherein the first clamping portion is formed with a first longitudinal groove on the face thereof facing the second clamping portion, the second clamping portion is formed with a second longitudinal groove on the face thereof facing the first clamping portion, the first longitudinal groove is parallel to the first direction and penetrates the narrow grooves of the first clamping portion, the second longitudinal groove is parallel to the second direction and penetrates the narrow grooves of the second clamping portion.

7. The pipe clamp pliers of claim 6, wherein the first longitudinal groove communicates with the first horizontal groove, the second longitudinal groove communicates with the second horizontal groove.

8. The pipe clamp pliers of claim 6, wherein the first longitudinal groove is near one of the lateral faces of the first clamping portion, the second longitudinal groove is near one of the lateral faces of the second clamping portion.

9. The pipe clamp pliers of claim 8, wherein an angle between a bottom face of the first longitudinal groove and a lateral face of the first longitudinal groove more remote from said lateral face of the first clamping portion is smaller than 90 degrees, an angle between a bottom face of the second longitudinal groove and a lateral face of the second longitudinal groove more remote from said lateral face of the second clamping portion is smaller than 90 degrees.

10. The pipe clamp pliers of claim 6, wherein two opposite ends of the first longitudinal groove penetrate a top face and a bottom face of the first clamping portion respectively, two opposite ends of the second longitudinal groove penetrate a top face and a bottom face of the second clamping portion respectively.

11. The pipe clamp pliers of claim 1, wherein each of the first pivot portion and the second pivot portion is a pivot hole, a pivot element is inserted through the two pivot holes.

12. The pipe clamp pliers of claim 1, wherein the first clamping member has a first receiving groove, the second clamping member has a second receiving groove, an elastic element is arranged in the first receiving groove and the second receiving groove so that the first clamping portion and the second clamping portion tend to move away from each other.

13. The pipe clamp pliers of claim 12, wherein each of the first pivot portion and the second pivot portion is a pivot hole and is located in the first receiving groove or the second receiving groove, a pivot element is inserted through the two pivot holes, the elastic element is sleeved onto the pivot element.

14. The pipe clamp pliers of claim 1, wherein a gripping sleeve is sleeved onto each of the first holding portion and the second holding portion.

15. The pipe clamp pliers of claim 1, both of the angle between the first lateral face and the first bottom face and the angle between the third lateral face and the second bottom face are smaller than 90 degrees.

16. The pipe clamp pliers of claim 15, the angle between the first lateral face and the first bottom face is ranged between 50 to 70 degrees, the angle between the third lateral face and the second bottom face is ranged between 50 to 70 degrees.

17. The pipe clamp pliers of claim 15, an angle between the second lateral face and the first bottom face is smaller than 90 degrees, an angle between the fourth lateral face and the second bottom face is smaller than 90 degrees.

18. The pipe clamp pliers of claim 17, wherein the first lateral face is substantially parallel to the second lateral face, the third lateral face is substantially parallel to the fourth lateral face.

19. The pipe clamp pliers of claim 15, wherein the first bottom face is substantially parallel to the face of the first clamping portion facing the second clamping portion, the second bottom face is substantially parallel to the face of the second clamping portion facing the first clamping portion.

20. The pipe clamp pliers of claim 15, wherein a width of the first bottom face is 1.15-1.2 times a depth of the first horizontal groove, a width of the second bottom face is 1.15-1.2 times a depth of the second horizontal groove.
